(19) United States
(12) Patent Application Publication
(10) Pub. No.: US 2011/0258864 A1
(43) Pub. Date: Oct. 27, 2011

(54) HAND SAW WITH CURVED CUTTING EDGE

(76) Inventors: Gabriel Carlson, Los Angeles, CA (US); Hanjin Park, Los Angeles, CA (US)

(21) Appl. No.: 12/898,935

(22) Filed: Oct. 6, 2010

Related U.S. Application Data
(63) Continuation-in-part of application No. 12/799,625, filed on Apr. 27, 2010.

(51) Int. Cl. B27B 21/00; B25G 3/00; B23D 49/10

(52) U.S. Cl. 30/517; 29/428

(57) ABSTRACT

A hand saw with a curved cutting edge is described. The hand saw includes a handle for grasping by a user and an elongated blade attached with the handle. The blade has cutting edge that is curved to form a curved blade edge. Due to its curvature, when the curved bladed edge is placed on a flat surface, a reduced portion of the curved blade edge engages with the flat surface. Additionally, the elongated blade is bound by a top edge, a bottom edge that forms the curved blade edge, and a front edge that intersects the top edge and bottom edge. A curved tip is formed at an intersection of the bottom edge with the front edge. The curved blade edge includes cutting markings for cutting a surface that are formed on the elongated blade and continue past the bottom edge and along the curved tip.

### PRIORITY CLAIM

The present application is a Continuation-in-Part application of U.S. Non-provisional application Ser. No. 12/799,625, filed on Apr. 27, 2010, entitled, “TOY TOOLS AND CUTTING SURFACE.”

### BACKGROUND OF THE INVENTION

(1) Field of Invention

The present invention relates to a saw with a unique cutting edge and, more particularly, to a hand saw with a curved cutting edge.

(2) Description of Related Art

Toy tools have long been known in the art. Such toy tools are typically plastic tools and tool sets that simulate the look of real tools, albeit made safe through the use of plastic and smooth edges. Traditional toy tools allow a child to “pretend” to construct various items through role play and imagination. The inventors of the present invention recently devised a children's tool kit that includes children's tools that are used to cut and assemble foam pieces.

Although a tool set can be assembled that includes a saw to cut foam, a traditional saw can often be difficult for children to use. When properly using a saw blade and positioning the blade at the edge of the surface, the force of the moving blade is focused at a single point (or small area), thereby increasing the efficiency of the blade. However, because children are not accustomed to cutting boards, planks, and other items at an angle, they often place the saw blade flat upon the surface to be cut. In other words, children often position the entire length of the saw blade upon the surface to be cut, which spreads the point of friction across the large surface blade. Thus, when the saw blade is positioned flat across the surface to be cut, it can be difficult for the child or user to generate the sawing motion and for the teeth of the cutting edge to effectively remove material.

Such inexperience with saws is not limited to children's toys and can be applied across the board, including adults and real saws. Thus, a continuing need exists for a hand saw with a unique cutting edge that accounts for user error in placement of the cutting edge across the surface to be cut.

### SUMMARY OF INVENTION

While considering the failure of others to make use of all of the above components in this technology space, the inventor unexpectedly realized that a saw with a curved cutting edge can be effectively used by children to refocus the cutting strength of the saw at a single point, despite user error.

More specifically, the hand saw includes a handle for grasping by a user and an elongated blade attached with the handle. The blade has cutting edge that is curved to form a curved blade edge. Due to its curvature, when the curved bladed edge is placed on a flat surface, a reduced portion of the curved blade edge engages with the flat surface. Additionally, the elongated blade is bound by a top edge, a bottom edge that forms the curved blade edge, and a front edge that intersects the top edge and bottom edge. A curved tip is formed at an intersection of the bottom edge with the front edge. The curved blade edge includes cutting markings for cutting a surface that are formed on the elongated blade and continue past the bottom edge and along the curved tip.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a an illustration of a kit with a saw according to the present invention;

FIG. 2 is an illustration of a saw with a curved blade according to the present invention;

FIG. 3A is a top-view illustration of the saw with a curved blade according to the present invention;

FIG. 3B is a left, side-view illustration of the saw with a curved blade according to the present invention;

FIG. 3C is a bottom-view illustration of the saw. with a curved blade according to the present invention;

FIG. 3D is a right, side-view illustration of the saw with a curved blade according to the present invention;

FIG. 3E is a rear-view illustration of the saw with a curved blade according to the present invention;

FIG. 3F is a front-view illustration of the saw with a curved blade according to the present invention; and

FIG. 4 is an illustration of a kit for building a foam airplane.

### DETAILED DESCRIPTION

The present invention relates to a saw with a unique cutting edge and, more particularly, to a saw with a curved cutting edge. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### DESCRIPTION

The present invention is directed to a saw with a unique cutting edge that enables a user to easily focus the force of the saw on a cutting point. Although the saw is described as being designed for children and included with a children's tool kit, it should be understood that the present invention is not intended to be limited thereto as it can be employed by users of any age as a stand-alone tool without incorporation into a kit and as a real tool. Thus, although the saw may be described as a toy, it should be understood by one skilled in the art that the present invention is not limited thereto and can be applied to real tools and real saws.

Nevertheless, for illustrative purposes only, the saw will first be described in conjunction with a kit having toy tools and foam boards (i.e., cutting surfaces) or pieces that can be safely cut with the toy tools. Thus, in this non-limiting example, a children's line of hand tools (e.g., the saw) is intended to be used with foam materials to mimic the use of “real” tools with “real” materials to create a variety of objects. Objects that can be created will be of any scale, ranging from small hand held pieces, robots, planes, all the way up to life-size forts and rafts, etc. The possibilities are only limited by the child's creativity. This provides for a safe environment in which the child can play and create.

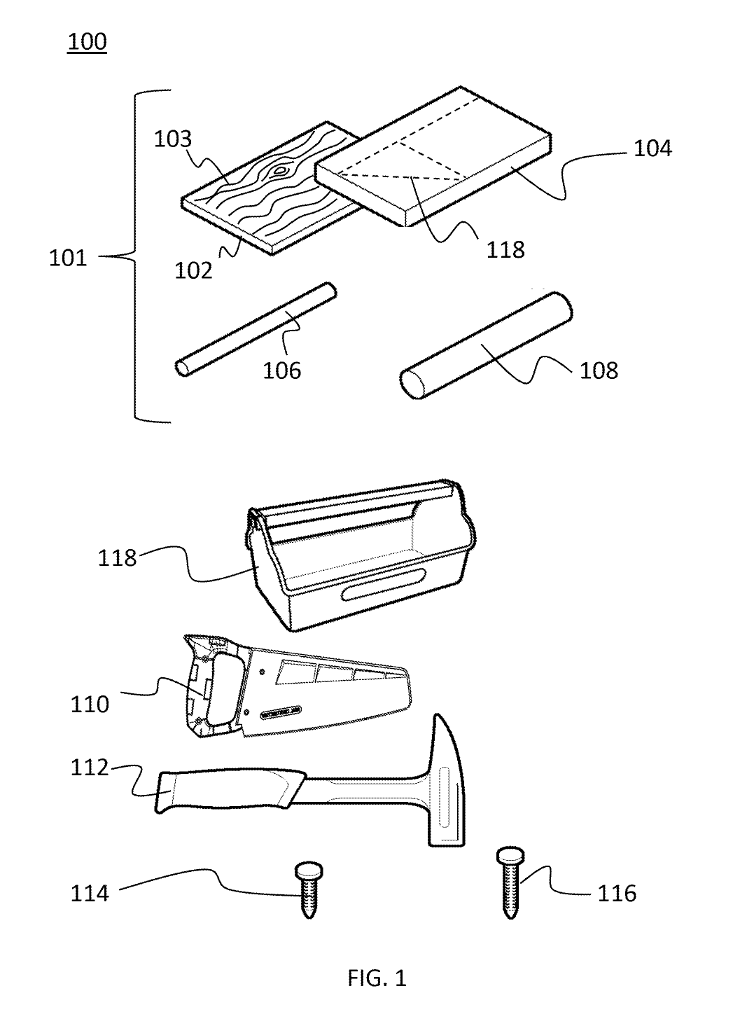

As shown in FIG. 1, such a kit 100 includes a variety of items for use in constructing a variety of items. For example, the kit 100 can include foam pieces 101 of varying sizes and thickness', such as a first foam board 102 (with a wood grain pattern 103) and a second 104, thicker foam board. The foam boards can come in any suitable sizes and in any suitable number. As a non-limiting example, the first foam board 102 includes the dimensions of 0.25 inches×5.75 inches×10.25 inches, while the second foam board 104 includes the dimensions of 0.75 inches×5.75 inches×10.25 inches. Other examples of foam pieces 101 include foam dowels or cylinders. Again, the foam can come in any suitable form and size. As a non-limiting example, a first foam cylinder 106 includes the dimensions of 0.75 inches in diameter×10.25 inches in length, while a second foam cylinder 108 includes the dimensions of 1.5 inches in diameter by 10.25 inches in length.

For cutting such foam pieces 101, the kit 100 includes at least one tool. As can be appreciated, any suitable type and number of tools can be used. As a non-limiting example, the kit 100 includes a saw 110 according to the present invention, a hammer 112, and fasteners, such as a small nail 114 and a large nail 116. To hold the tools and fasteners (and foam), the kit 100 can include a tool box 118 or carrying case.

Additionally, any of the foam pieces, such as the second foam board 104, can include score marks and/or markings 118 to provide a cut-pattern for the user. Thus, through the markings 118, the user can easily cut a pattern out of the foam pieces to assemble a desired item. Such a pattern can be easily cut using the saw 110 of the present invention.

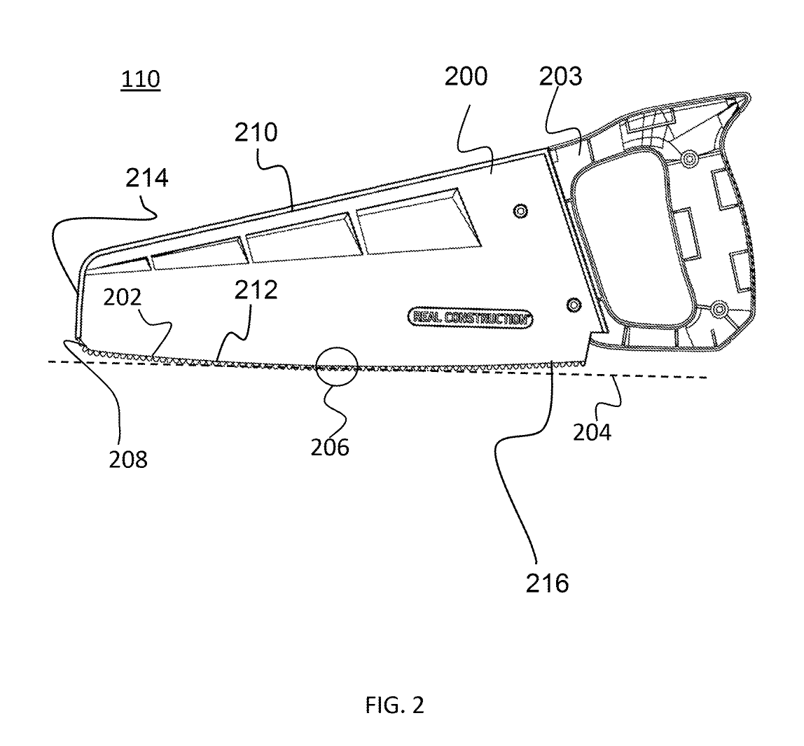

As shown in FIG. 2, the saw 110 is a hand-powered curved-blade saw. As noted above, some inexperienced users of a saw position the entire length of the saw blade upon the surface to be cut, which spreads the point of friction across the entire blade. Thus, to increase the cutting efficient of the present invention, the curved-blade saw 110 of the present invention includes an elongated blade 200 (with a curved bladed edge 202) that is affixed (via screws, etc.) with a handle 203. For comparison, a straight line 204 is drawn and positioned against the curved blade edge 202. As can be seen, the curved blade edge 202, due to its curvature, touches the straight line or any other flat surface at a reduced portion 206 of the blade edge (such as a single point). Thus, through the curved blade edge 202, an inexperienced user (such as a child using the saw) can easily focus the force of the saw 110 to a reduced portion 206 or single point and thereby engage with and cut the item to be cut. In other words, the reduced portion 206 operates as a single point of tangency on the materials to be cut, focusing the power of the cutting edge at a single location, thereby improving the efficiency of the cutting edge.

Another notable feature of the saw 110 is that it includes a curved tip 208. When using a saw, children often jam the saw into the item to be cut. Saws of the prior art include a sharp tip which, when jammed into the item to be cut, forced the tip of the saw to dig into the item to be cut and prevents the teeth of the saw from sliding/sawing across the item. However, the saw 110 according to the present invention includes a curved tip 208 that allows the saw to cut into and continue cutting the item as the saw 110 is pushed forward. In other words, instead of being jammed into the item via a sharp time, the curved tip 208 allows the saw to slide across the item to begin the cutting process.

For further understanding, the elongated blade 200 is bound by a top edge 210, a bottom edge 212 (which is synonymous with the curved blade edge 202), and a front edge 214. The front edge 214 intersects both the top edge 210 and bottom edge 212. The curved tip 208 is formed at the intersection of the bottom edge 212 with the front edge 214. To cut the surface, the curved blade edge 202 includes cutting markings 216. For example, the cutting markings 216 can be serrations or saw teeth that assist the curved blade edge 202 to cut a particular surface. The cutting markings 216 that are present on the curved blade edge 202 continue past the bottom edge 212 and along the curved tip 208.

As noted above, in some aspect, the present invention can be employed as a child's saw to allow a child to safely cut a surface. As such, the elongated blade 200 is formed of any suitable material to cut a surface and prevent injury to a child. For example, the elongated blade 200 can be formed of metal. However, in another aspect, the elongated blade 200 is formed of plastic to reduce injury to a child or other user.

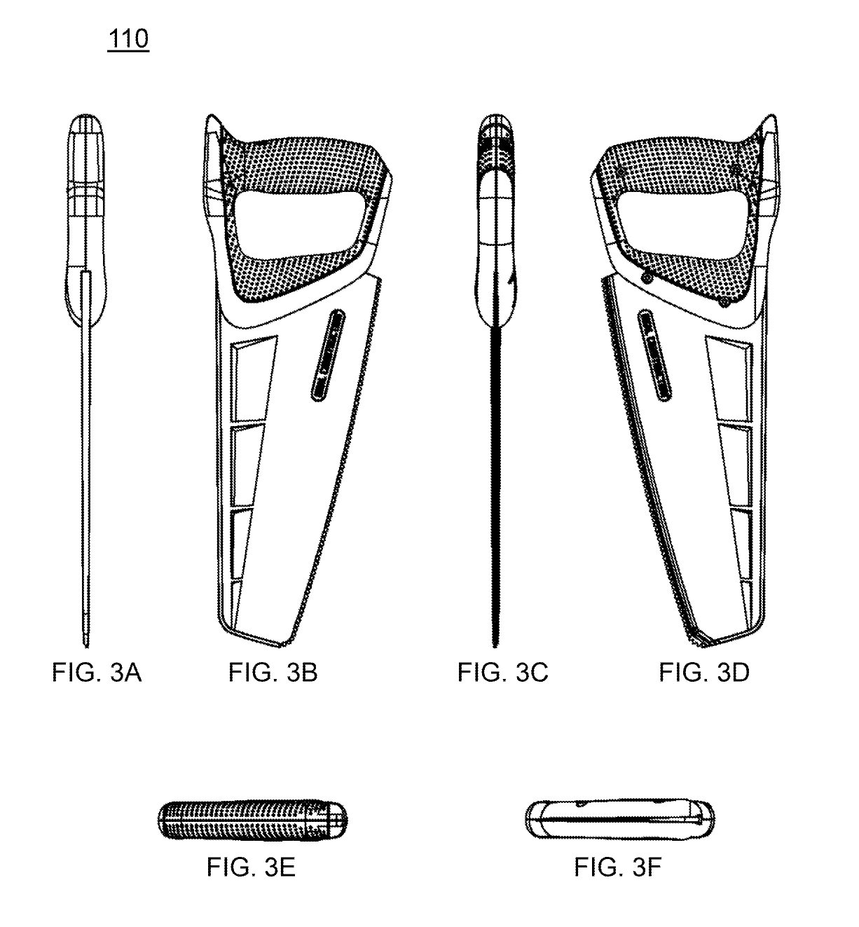

For further illustration, FIGS. 3A through 3F depict top, left, bottom, right, rear, and front-views, respectively, of the saw 110.

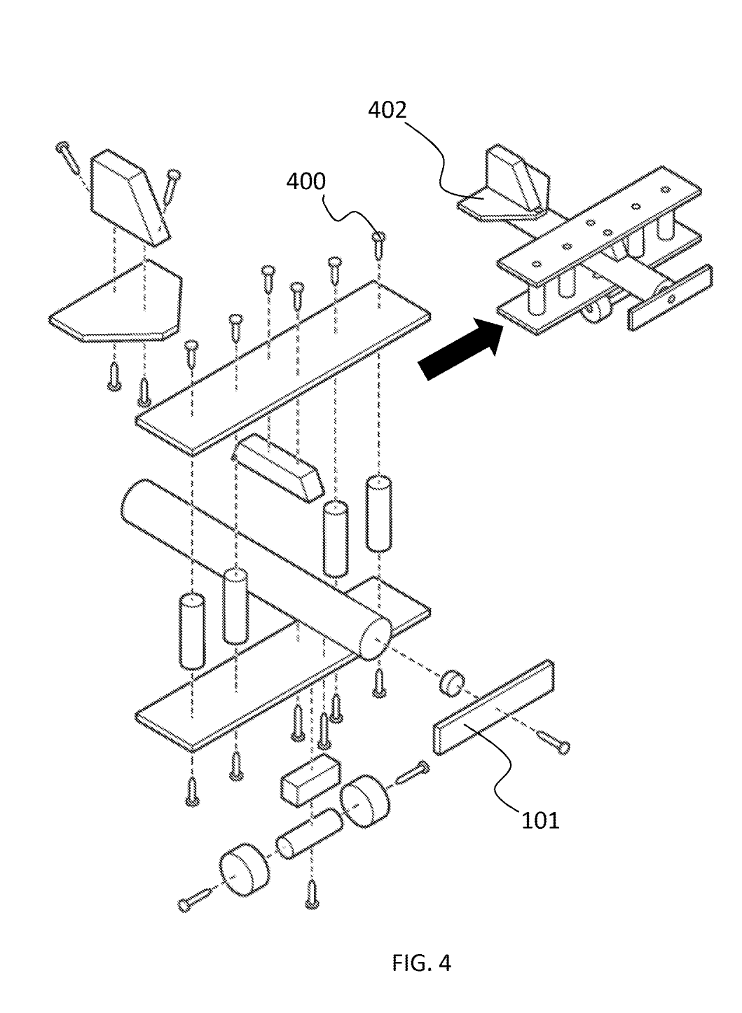

As noted above, the present invention can be used to cut a variety of items (e.g., foam) to form a variety of objects. FIG. 4 provides a non-limiting example of such an item. It should be understood that the example depicted in FIG. 4 is for illustrative purposes only as the present invention is not intended to be limited thereto. Thus, FIG. 4 depicts a variety of foam pieces 101 and fasteners 400 that can be used to construct a foam airplane 402.

What is claimed is:

1. A hand saw for cutting surfaces, comprising:
a handle for grasping by a user; and
an elongated blade attached with the handle, the blade having cutting edge that is curved to form a curved blade edge, whereby due to its curvature, when the curved bladed edge is placed on a flat surface, a reduced portion of the curved blade edge engages with the flat surface.

2. The hand saw according to claim 1, wherein the elongated blade is bound by a top edge, a bottom edge that forms the curved blade edge, and a front edge that intersects the top edge and bottom edge, and wherein a curved tip is formed at an intersection of the bottom edge with the front edge.

3. The hand saw according to claim 2, wherein the curved blade edge includes cutting markings for cutting a surface, the cutting markings are formed on the elongated blade to continue past the bottom edge and along the curved tip.

4. A method for forming hand saw for cutting surfaces, comprising acts of:
forming a handle for grasping by a user; and
attaching an elongated blade with the handle, the blade having cutting edge that is curved to form a curved blade edge, whereby due to its curvature, when the curved bladed edge is placed on a flat surface, a reduced portion of the curved blade edge engages with the flat surface.

5. The method according to claim 4, wherein the elongated blade is bound by a top edge, a bottom edge that forms the curved blade edge, and a front edge that intersects the top edge and bottom edge, and wherein a curved tip is formed at an intersection of the bottom edge with the front edge.

6. The method according to claim 5, wherein the curved blade edge includes cutting markings for cutting a surface, the cutting markings are formed on the elongated blade to continue past the bottom edge and along the curved tip.
